(19) United States
(12) Patent Application Publication
(10) Pub. No.: US 2016/0300271 A1
(43) Pub. Date: Oct. 13, 2016

(54) SYSTEM FOR OFFER AND ACCEPTANCE BASED ONLINE CLASSIFIED ADS

(71) Applicant: William Alexander Scroggins, III, Bowling Green, KY (US)

(72) Inventor: William Alexander Scroggins, III, Bowling Green, KY (US)

(21) Appl. No.: 14/859,402

(22) Filed: Sep. 21, 2015

Related U.S. Application Data
(60) Provisional application No. 62/146,246, filed on Apr. 11, 2015.

(51) Int. Cl. G06Q 30/02; G06F 3/0484; G06F 17/30

(52) U.S. Cl. CPC G06Q 30/0277; G06F 17/30477; G06F 17/30598; G06F 3/0484

(57) ABSTRACT

A system for: saving searches in an online classified ad system for quick manual execution later or automatic scheduled execution; matching online classified ads that represent wants for a good and/or service to ads capable of fulfilling said good and/or service and notifying the ad posters of the matches found for their ads; providing a method for the bulk creation of ads represented in an input file; providing a means for users to respond to an online classified ad by making an offer; providing a means for the poster of an online classified ad to accept one of many offers; and providing a means for the parties involved in a completed online classified ad transaction to rate each other and leave reviews based upon their overall experience.

### BACKGROUND OF INVENTION

Embodiments of the present invention generally relate to online classified ads. More specifically, embodiments of the present invention relate to systems for facilitating the buy, sell, trade, or other exchange of goods or services described in online classified ads by supplementing an online classified ad system with advanced searching, matching, and data-entry capabilities and an offer/acceptance model.

In the traditional newspaper classified ad systems as well as in online classified ad systems, buyers can place ads for goods or services wanted, and sellers can place ads for goods and services for sale. Both types of ads typically include a title, a description of the good or service, the poster's contact information, and a price.

U.S. Pat. No. 5,283,731 to Lalonde and Dettmann (1994) identifies several issues with newspaper classified ad systems. One problem is that buyers must often scan a large number of classified ads in search of the good or service that matches their needs. A second problem is that of timing: that is, by the time that a buyer is able to contact the seller, the good or service could no longer be available. A third problem is that a buyer may not be able to locate a suitable good or service in a given day's newspaper, resulting in the buyer potentially re-reading previously read classified ads on following days since ads are generally not organized by date.

Online classified ad systems address some of the issues with newspaper classifieds, by providing search capabilities and additional means of communicating with the posters of ads, such as through email. However, online classified systems have their own issues. The first problem is that users must often repeat searches until they find an ad that matches their needs. A second problem is that users must specify a geographic area when conducting a search. In this way, online classifieds are similar to newspaper classifieds: the ads shown to individuals are limited to a specific geographic area. A third problem with online classified ads is there is often no way to purchase goods or services online. This is because online classified ad systems, like newspaper classified ad systems, still promote the practice of conducting business in person at the local level. A fourth problem is that posters of ads might receive several responses to their ads, each with different offers or terms; the posters of these ads lack an effective means for organizing the offers made to them and must review them manually to identify the most pleasing offer. A fifth problem with online classified ads is that they are frequently used and abused by spammers and scammers.

### SUMMARY OF THE INVENTION

A system is described for facilitating the buy, sell, trade, or other exchange of goods or services stated in online classified ads by supplementing an online classified ad system with advanced searching, matching, and data-entry capabilities and an offer/acceptance model. More specifically, methods and systems are described for: saving searches in an online classified ad system for quick manual execution later or automatic scheduled execution; matching online classified ads that represent wants for a good and/or service to ads capable of fulfilling said good and/or service and notifying the ad posters of the matches found for their ads; providing a method for the bulk creation of ads represented in an input file; providing a means for users to respond to an online classified ad by making an offer; providing a means for the poster of an online classified ad to accept one of many offers; and providing a means for the parties involved in a completed online classified ad transaction to rate each other and leave reviews based upon their overall experience.

Features of embodiments of the present invention will be apparent from the drawings and detailed description that follows.

### BRIEF DESCRIPTION OF THE DRAWINGS

Referring to the drawings which are appended hereto and which form a portion of this disclosure, it may be seen that:

FIG. 1 depicts a client-server environment such as the World Wide Web (the Web) in which electronic commerce involving online classified ads may take place.

FIG. 2 is one embodiment of a computer system that may be used as a client or server in an online classified system.

FIG. 3 is a simplified diagram illustrating an architecture for supporting the creation of an electronic commerce enabled online classified system according to one embodiment of the present invention.

FIG. 4 is a flow diagram illustrating the process of enabling categories of online classified ads for matching according to one embodiment of the present invention.

FIG. 5 is a flow diagram illustrating the process of matching online classified ads according to one embodiment of the present invention.

FIG. 6 is a flow diagram illustrating the process of offer and acceptance applied to online classified ads involving a payment that is made online according to one embodiment of the present invention.

FIG. 7 is a flow diagram illustrating the process of offer and acceptance applied to online classified ads involving a payment that is made in-person according to one embodiment of the present invention.

FIG. 8 illustrates a user interface screen through which a person may post an online classified ad according to one embodiment of the present invention.

FIG. 9 illustrates a user interface screen through which a person may respond to an online classified ad by making an offer according to one embodiment of the present invention.

FIG. 10 illustrates a user interface screen through which the owner of an ad can accept one of many offers received for a given ad according to one embodiment of the present invention.

FIG. 11 illustrates a user interface screen available after a completed classified ad transaction in which the owner of the ad can leave a review and rating of the owner of the accepted offer according to one embodiment of the present invention.

FIG. 12 illustrates a user interface screen available after a completed classified ad transaction in which the owner of the accepted offer can leave a review and rating of the owner of the ad according to one embodiment of the present invention.

FIG. 13 is a flow diagram illustrating the process of saved searches of online classified ads according to one embodiment of the present invention.

FIG. 14 is a flow diagram illustrating the process of uploading a file containing one or more records to an online classified ad data store for bulk creation of online classified ads according to one embodiment of the present invention.

FIG. 15 illustrates a user interface screen through which a user may upload a file containing one or more records for bulk creation of online classified ads according to one embodiment of the present invention.

### DETAILED DESCRIPTION

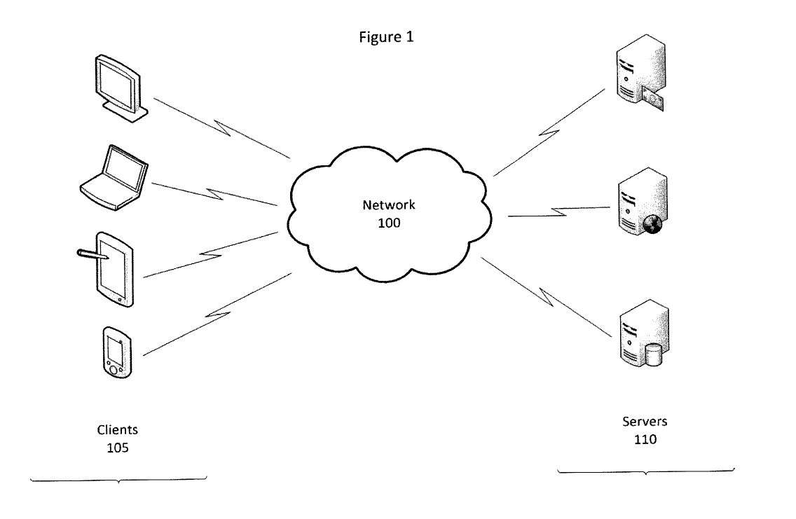

One or more of the above objects can be achieved, at least in part, by providing FIG. 1 depicts a client-server environment such as the World Wide Web (the Web), in which electronic commerce involving online classified ads may take place. The architecture of the Web follows a conventional client-server model. The terms “client” and “server” are used to refer to a computer's general role as a requester of data (the client) or provider of data (the server). In the present example, Web clients 105 and Web servers 110 communicate using a protocol such as Hypertext Transfer Protocol (HTTP). Web browsers reside in Web clients 105 and render Web documents, or Web pages, served to them by Web servers 110.

In the present example, Web servers 110 are coupled to a public network 100 such as the Internet and respond to document requests and/or other commands issued from Web clients 105. When a user selects a document by submitting its Uniform Resources Locator (URL) or by selecting a hyperlink associated with the document, a Web browser opens a connection to the appropriate Web server 110 and initiates a request, such as an HTTP GET request, for the document. The Web server responds to the request with the appropriate document, typically in the form of a text document coded in a standard markup language such as Hypertext Markup Language (HTML) which is interpreted by the Web browser.

According to various embodiments of the present invention, client-side users are prospective buyers and/or sellers of goods and/or services that use Web clients 105 such as personal computers, mobile phones, voice user interfaces, or other interfaces to create, modify, search for, review, respond to, and otherwise interact with electronic commerce enabled online classified ads.

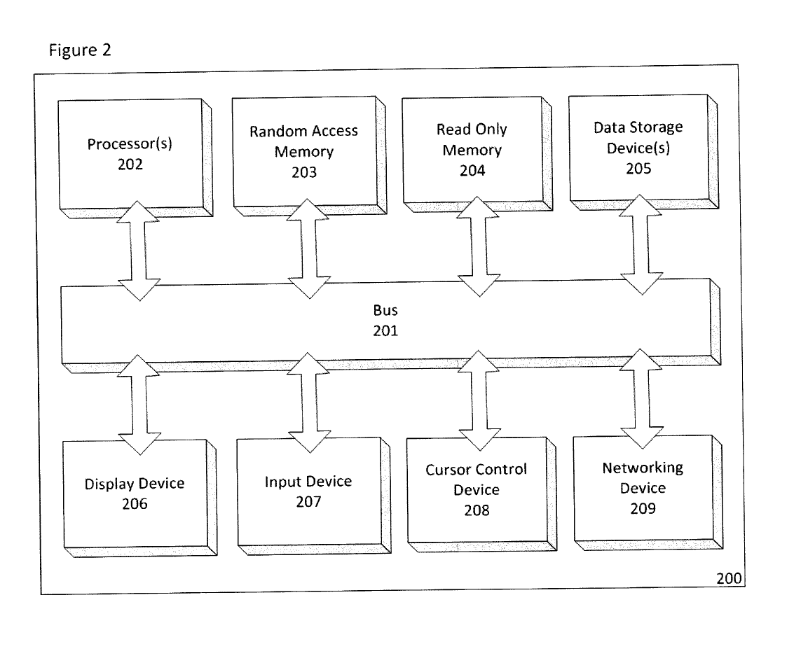

FIG. 2 is one embodiment of a computer system that may be used as a client or server in an online classified system. Computer system 200 comprises a bus or other communication means 201 for communicating information, and a processing means such as one or more processors 202 coupled with bus 201 for processing information. Computer system 200 further comprises a random access memory (RAM) as a dynamic storage device 203 coupled to bus 201 for storing information and instructions to be executed by processor(s) 202. Random access memory 203 also may be used for storing temporary variables or other intermediate information during execution of instructions by processor(s) 202. Computer system 200 also comprises read only memory (ROM) as a static storage device 204 coupled to bus 201 for storing information and instructions for processor(s) 202. Data storage device(s) 205 may also be coupled to bus 201 for storing information and instructions. Data storage device(s) such as magnetic disk, optical disc, or any other mass storage device may be used.

Computer system 200 can also be coupled via bus 201 to display device 206, such as cathode ray tube (CRT), liquid crystal display (LCD), television (TV), projector, or other devices in order to display information to a computer user.

Often an alphanumeric input device 207, including alphanumeric and other keys, is coupled to bus 201 for communicating information and/or commands to processor(s) 202. Another type of user input device is cursor control 208, such as a mouse or trackball, for communicating information and/or commands to processor(s) 202 and for controlling cursor movement on a display.

Computer system 200 may be coupled to a network, such as network 100 via a network interface, modem, or other device 209.

Embodiments of the present invention may make use of a computer system such as computer system 200 to host and execute an online classified ad system and to store, retrieve, transfer, transform, and/or analyze online classified ad data.

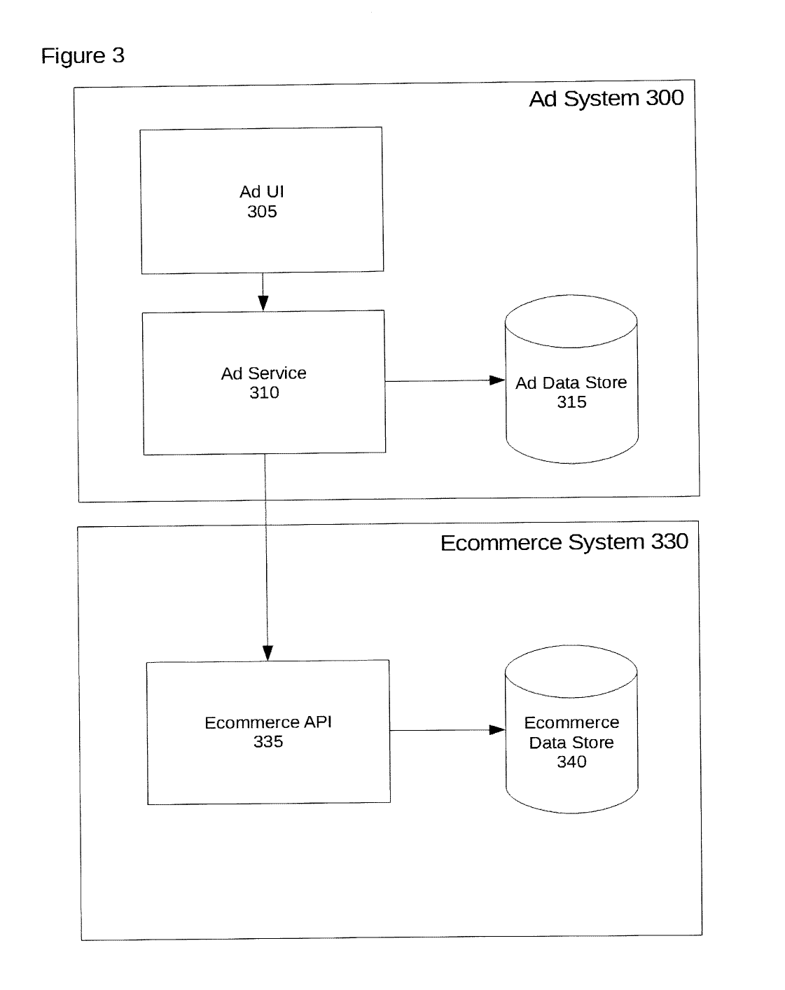

FIG. 3 is a simplified diagram illustrating an architecture for supporting the creation of an electronic commerce enabled online classified system according to one embodiment of the present invention.

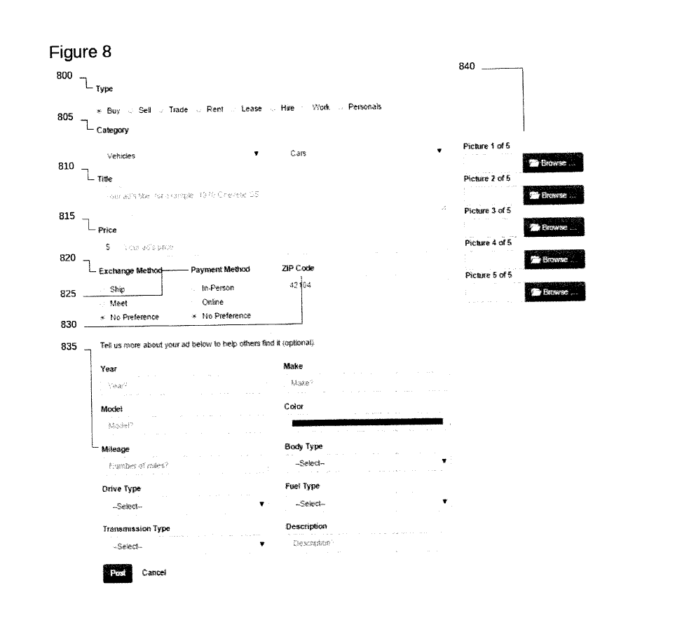

The architecture consists of ad system 300 and ecommerce system 330. Ad user interface (UI) 305 is used by prospective buyers and/or sellers of goods and/or services to create, modify, search for, review, respond to, and otherwise interact with electronic commerce enabled online classified ads that are persisted to ad data store 315 via ad service 310. As discussed hereinafter in connection with FIG. 8, a user interface 800 is generated to guide the user in providing the proper information.

If two users enter into a buy/sell agreement that requires a payment, ad service 310 invokes the ecommerce application programmer interface (API) 335 to handle the payments. Specifically, ecommerce API 335 is invoked to invoice the buyer, charge the buyer's credit or debit card, and/or debit the buyer's ecommerce system account in the amount of the sales price; the ecommerce API 335 is also invoked to credit the seller in the amount of the sales price minus a commission and/or service charge. Whenever ecommerce API 335 is invoked, any ecommerce data generated is stored in ecommerce data store 340.

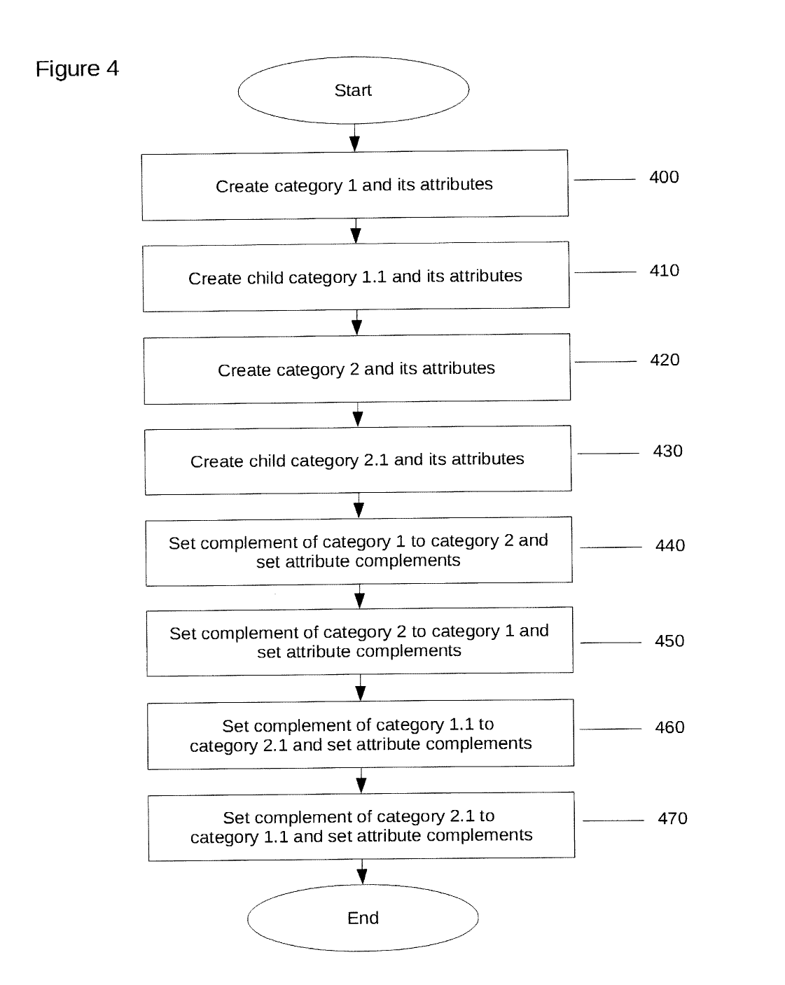

FIG. 4 is a flow diagram illustrating the process of enabling categories of online classified ads for matching.

At block 400, an initial category 1 and its attributes are created. An attribute has a name and a data type such as number, date, or text to indicate what kind of data is allowed for that attribute. In one embodiment of the present invention, an attribute also has an offerable flag (meaning it should be shown as an input field in the offer user interface), a searchable flag (meaning it can be used as a parameter in searches), a search weight (if it is searchable), a matchable flag (meaning it can be matched to a complement attribute on another category of ad), a required flag, a minimum acceptable length, a maximum acceptable length, a minimum acceptable value, a maximum acceptable value, a unit of measure if applicable, a predefined list of acceptable values if applicable, and a list of possible suggested values to be used if the attribute is a freeform field in which anything can be entered, but for which suggestions or recommendations are desired.

At block 410, a child of category 1, category 1.1, and its attributes are created. Any attributes created for the parent category (category 1) are inherited by category 1.1. There are two purposes of this hierarchical relationship between categories. First, similar categories with overlapping attributes can be grouped via a parent category, and the common attributes can be defined once for the parent category instead of duplicated across numerous child categories. For example, a category for tables and a category for sofas can have a parent category created called furniture; the furniture category can contain general furniture attributes such as color, material, style, and an assembly required flag so that these attributes are not duplicated in both the table category and the sofa category. Another purpose for allowing a hierarchical relationship between categories is to allow searches to be executed across a top or high-level category (e.g., furniture), and results can be fetched from the descendant categories (e.g., tables, sofas, etc.). For example, a person may search the system for all want ads in the furniture category with a value for the color attribute set to dark red. In this case, the search results returned to the user should include ads from the parent category (furniture) as well as all child categories of furniture (tables, sofas, etc.) that have a value for the color attribute set to dark red.

At block 420, category 2 and its attributes are created.

At block 430, a child of category 2, category 2.1, and its attributes are created. Any attributes created for the parent category (category 2) are inherited by category 2.1.

At block 440, category 1 is modified; its complement is set to category 2. Also, the attributes of category 1 are modified; their complements are set to the corresponding attributes of category 2. This allows ads of category 2 to be matched to ads of category 1.

At block 450, category 2 is modified; its complement is set to category 1. Also, the attributes of category 2 are modified; their complements are set to the corresponding attributes of category 1. This allows ads of category 1 to be matched to ads of category 2. There is now a reciprocal relationship between categories 1 and 2. This reciprocal relationship between categories is used to control the way in which ads are matched. Ads of category 1 should only be matched to ads of category 2, and the reverse is true (ads of category 2 should only be matched to ads of category 1). As an example, suppose category 1 is a category called Buy Computers, and category 2 is a category called Sell Computers. By setting the complement of Buy Computers to Sell Computers, when a user posts an ad for Buy Computers, according to one embodiment of the present invention, the user can be shown on a web page similar ads in the complement category (Sell Computers). In another embodiment of the present invention, users are periodically emailed matches to their ads; the matches that are sent to a given user are limited to ads in the complement category of the user's ad. Complement attributes are used to control how ads of two complementary categories are matched together. For example, in continuing with the Buy Computers and Sell Computers scenario, the Buy Computers category has an attribute called Type (as in “desktop” or “laptop”) and Description; the Sell Computers category also has the Type and Description attributes. The complement attribute of the Buy Computers Type attribute is the Sell Computers Type attribute (and the reverse is true: the complement of the Sell Computers Type attribute is the Buy Computers Type attribute). This reciprocal relationship between attributes means that the Type attribute of a Buy Computers ad should only ever be compared to the Type attribute on the Sell Computers category when determining whether two ads match each other and vice versa. Note that not all attributes have a complement attribute. For example, a Sell Cars category has a Vehicle Identification Number (VIN) attribute, but a Buy Cars category does not have this attribute, as this would not make sense. The VIN attribute on the Sell Cars category therefore will not be compared to any attributes on a Buy Cars ad when determining whether two ads match.

At block 460, category 1.1 is modified; its complement is set to category 2.1. Also, the attributes of category 1.1 are modified; their complements are set to the corresponding attributes of category 2.1. This allows ads of category 2.1 to be matched to ads of category 1.1.

At block 470, category 2.1 is modified; its complement is set to category 1.1. Also, the attributes of category 2.1 are modified; their complements are set to the corresponding attributes of category 1.1. This allows ads of category 1.1 to be matched to ads of category 2.1. Categories 1.1 and 2.1 now have a reciprocal relationship like the one described between categories 1 and 2.

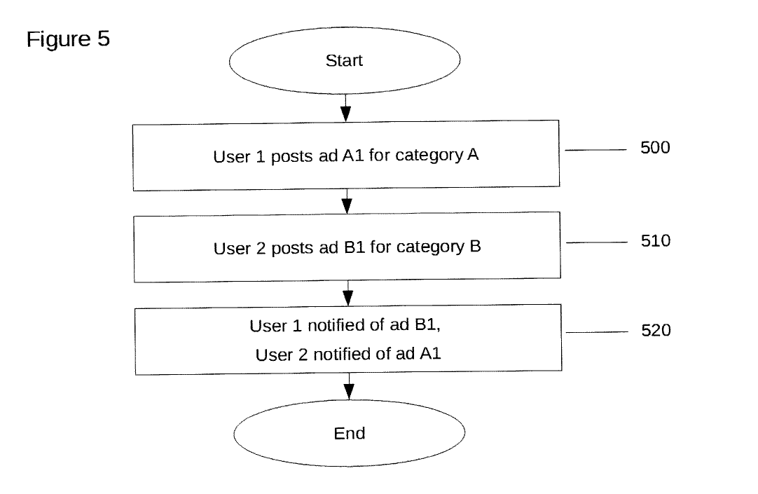

FIG. 5 is a flow diagram illustrating the process of matching online classified ads according to one embodiment of the present invention.

At block 500, user 1 posts ad A1 for category A.

At block 510, user 2 posts ad B1 for category B. Category B is the complement of category A, and category A is the complement of category B. Categories A and B therefore have a reciprocal relationship.

At block 520, user 1 is notified of ad B1, because ad B1 is the complement of his or her ad's category and therefore is a potential match for what user 1 is seeking. Also at block 520, user 2 is notified of ad A1, because ad A1 is the complement of his or her ad's category and therefore is a potential match for what user 2 is seeking.

In one embodiment of the present invention, users are only notified of potential matches if they are determined to be similar to one another; that is, if the text or values used in the attributes of the ads' categories match.

For example, consider category A is “Buy Sofa” and category B is “Sell Sofa”, and each of these categories has the following attributes: style, color, material, and number of seats; the complement of each of these attributes is the attribute of the same name in the opposite category. If a user posts a Buy Sofa ad for a modern gray fabric sofa that seats 3 people, and a second user posts a Sell Sofa ad for a modern gray fabric sofa that seats 3-4 people, the words “modern”, “gray”, and “fabric” used in both ads match, and the number of seats “3” from the first ad is within the range of “3-4” seats of the second ad; therefore, these two ads are considered to match and each user is notified of the match. However, if a third user posts a Sell Sofa ad for a contemporary brown leather sofa that seats 5 people, none of the attributes of this ad match the attributes of the Buy Sofa ad posted by the first user; therefore, since the ad of user 1 and 3 do not match, the users should not be notified. Note that in this embodiment, exact matches between ads are not required in order for notifications to be sent; ads may fuzzily match (not 100% match) in order to be sent in notifications. In this embodiment, users can set a threshold for the percentage that ads must match in order to be included in notifications. This threshold is also used to validate offers during the offer creation process; that is, in order for an offer to be allowed on a given ad, the offer must meet the matching threshold the ad's poster requires.

In one embodiment of the present invention, notifications of matches are sent periodically via one of more via one of more notification mediums such as email; matches can be grouped together so that multiple matches are included in a single notification, and within the notification, matches are sorted in order of descending relevancy (i.e., match percentage) so that the most relevant matches appear first; also, via a configurable user preference, users can control how frequently these notifications are sent. In another embodiment, immediately after posting an ad, a search is executed to find matching ads to show to the user along with an ad post success message; the matches shown are sorted by default in order of descending relevancy (i.e., match percentage), and can be resorted by price, geographic proximity (e.g., 20 miles away, 30 miles away, etc.), match percentage, or any other sortable attribute of the ad. In another embodiment, whenever users return to their posted ad to review it, matching ads are displayed in the user interface; the matches shown are sorted by default in order of descending relevancy (i.e., match percentage), and can be resorted by price, geographic proximity (e.g., 20 miles away, 30 miles away, etc.), match percentage, or any other sortable attribute of the ad.

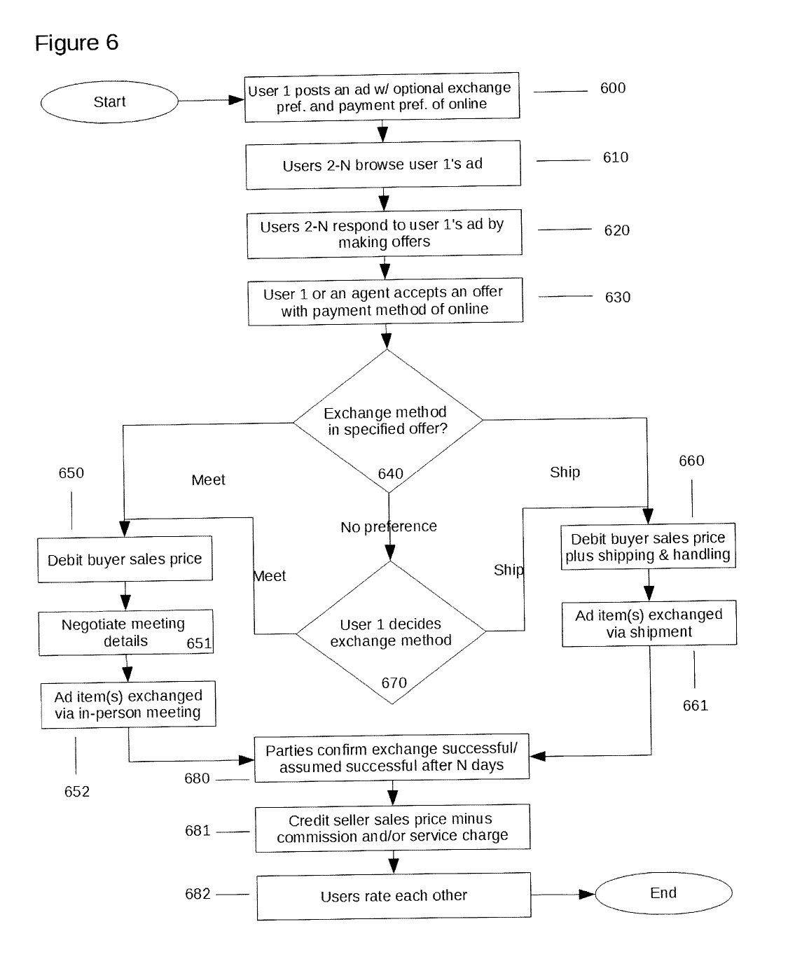

FIG. 6 is a flow diagram illustrating the process of offer and acceptance applied to online classified ads involving a payment that is made online according to one embodiment of the present invention.

At block 600, a user posts an ad to the online classified ad system. The ad may be for a good or service wanted, a good or service for sale, a good or service for trade for another good or service, or any other type of classified ad involving the exchange of a good or service. The poster of the ad may specify that the ad's offers should be publicly available to potentially increase competition among offerors attempting to have their offers accepted, or private so that offerors cannot see one another's offers. For buy and sell ads, the poster may also specify a price, an exchange preference (ship or meet) as well as a payment preference (online or in-person); the poster can further specify whether offers made in response to the ad must match the ad's price, or whether offers must be within a certain range of the ad's price (e.g., allow offers with prices 5% lower than the ad's price if the ad is a sell ad, $10.00 higher than the ad's price if the ad is a buy ad, etc.); whether offers must match the ad's exchange preference; and/or whether offers must match the ad's payment preference. If the price match required preference is set and the ad is a sell ad, the prices on offers must be greater than or equal to the price on the ad. If the price match required preference is set and the ad is a buy ad, the prices on offers must be less than or equal to the price on the ad. If the price range preference is set and the ad is a sell ad, the prices on offers can be no less than the lower bound specified on the ad. If the price range preference is set and the ad is a buy ad, the prices on offers can be no greater than the upper bound specified on the ad. Note that other types of ads may not have all or any of these preferences; for example, a trade ad can have an exchange preference but not a price or payment preference; a personals ad will obviously not have any of these fields.

At block 610, users of the online classified ad system may view the ad posted in block 600.

At block 620, users of the online classified ad system may respond to the ad posted in block 600 in the form of offers. When making an offer, the offer may either be blank, meaning all fields are keyed in manually, or based on an ad, which means the offer fields are defaulted to the corresponding fields on the offeror's own ad. When an offer is based on an ad, the offer also has a reference back to the ad, so that in the event the offer is accepted, the ad it is based upon may also be closed in order to preclude it from being included in future search results.

Whenever an offer is made, the poster of the ad is notified via one of more notification mediums such as email; via a configurable user preference, users can control how frequently these notifications are sent. A summary of the offer or the entire offer details may be sent in the notification. The notification also contains a reference such as a hyperlink to the offer in the online classified ad system.

At block 630, the poster of the ad or an agent on the behalf of the poster accepts an offer that has a payment method of online specified.

In one embodiment of the present invention, the poster specifies which characteristics of an offer are most important to him or her, such as price, geographic proximity, or similarity to the ad; in this embodiment, the ad considered best according to the poster's preferences is picked automatically after a certain number of days have elapsed so the poster doesn't have to manually review offers.

In another embodiment of the present invention, the poster manually reviews the offers that have been received. In this embodiment, the online classified ad system allows the ad poster to sort offers by price, geographic proximity (e.g., 20 miles away, 30 miles away, etc.), relevancy via match percentage, or any other sortable attribute of the offer, in order to help the ad poster identify the most desirable offers. However, it is ultimately the ad poster's decision which offer to accept in this embodiment.

Note that at any point after the poster has placed an ad and not yet accepted an offer, the poster may reject any offers received and optionally supply a message for why the offer was rejected and/or select a predefined reject reason to be sent to the offeror. If an offer is rejected, it may be revised and the poster of the ad will be notified so that the new offer may be reviewed.

At decision block 640, a determination is made regarding how the exchange of the ad item(s) will be conducted based on the preference specified in the accepted offer. If the accepted offer has specified the preferred exchange method is an in-person meeting, then the process of completing the exchange continues with block 650. If the accepted offer has specified the preferred exchange method is shipment, then the process of completing the exchange continues with block 660. If the accepted offer has specified no preference for the exchange method, then the process of completing the exchange continues to decision block 670. At decision block 670, the ad poster chooses the exchange method. If the ad poster chooses to complete the exchange via an in-person meeting, then the process of completing the exchange goes to block 650. If the ad poster chooses to complete the exchange via shipment, then the process of completing the exchange goes to block 660.

At block 650, if this ad requires the exchange of money, the buyer is debited for the amount of the sales price. According to one embodiment, this involves charging the buyer's credit or debit card, invoicing the buyer using of one of any online payment solutions, such as Amazon Payments or PayPal, and/or debiting the buyer's ecommerce system account in the amount of the sales price.

At block 651, users negotiate the details of an in-person meeting to complete the exchange. The offer itself may have a proposed meeting location, date, and time, and the poster of the ad may either accept the proposed meeting or instead propose a different meeting location, date, and/or time. Changes to the meeting details are communicated between the users via one of more communication mediums such as web pages, email, phone calls, instant messaging, text messaging, online chat, wireless text messaging, wireless application protocol (WAP), short message service (SMS), or real-time communication (RTC).

At block 652, users or delegates of the users physically meet in-person at the agreed upon location, date, and time, and complete the exchange. If the ad is for a good, the transfer of ownership of the good from the seller to the buyer is completed. If the ad is for a service, the service is either performed in-person at the meeting and/or evidence of entitlement to the service at future location(s), date(s), and time(s) is given from the seller to the buyer.

At block 660, if this ad requires the exchange of money, the buyer is debited for the amount of the sales price plus a shipping and handling fee. According to one embodiment, this involves charging the buyer's credit or debit card, invoicing the buyer using of one of any online payment solutions, such as Amazon Payments or PayPal, and/or debiting the buyer's ecommerce system account in the amount of the sales price plus a shipping and handling fee. In one embodiment, the sales price is final and includes shipping, handling, or any other miscellaneous fees; in this embodiment, the buyer will be debited in the amount of the sales price only.

At block 661, ad item(s) are shipped from the buyer to the seller. If the ad is for a good, the good is shipped from the seller to the buyer. If the ad is for a service, evidence of entitlement to the service is shipped from the seller to the buyer.

At block 680, the exchange of ad item(s) is recorded as complete in order to preclude the ad from being included in future search results. Also, if the accepted offer was based on an ad, the ad the offer was based upon is also closed in order to preclude it from being included in future search results. In one embodiment of the present invention, both parties (i.e., the poster of the ad and the creator of the accepted offer) access the system in order to confirm the exchange of the ad item(s) was successful. In another embodiment of the present invention, the exchange of ad item(s) is assumed to be successful after a certain number of days have elapsed (e.g., 15 days); in this embodiment, either party may access the system before this period elapses in order to report that the exchange was unsuccessful. When a party reports an exchange was unsuccessful, the administrators of the system are notified via one of more notification mediums such as email so that an investigation can be launched. If the investigation concludes that one of the parties is at fault and failed to adhere to the terms of the ad or offer, a corrective action may be made such as refunding a buyer his or her money in the event a seller did not ship an ad item at all or in the expected condition.

At block 681, if this ad requires the exchange of money, the seller is credited in the amount of the sales price minus a commission and/or service charge.

At block 682, the poster of the ad and the creator of the accepted offer may rate each other based upon their overall experience with the other party and can also provide reviews of their experiences. In one embodiment of the present invention, the rating system is a five (5) point rating system and reviews can be text-based, image-based, audio-based, and/or video-based.

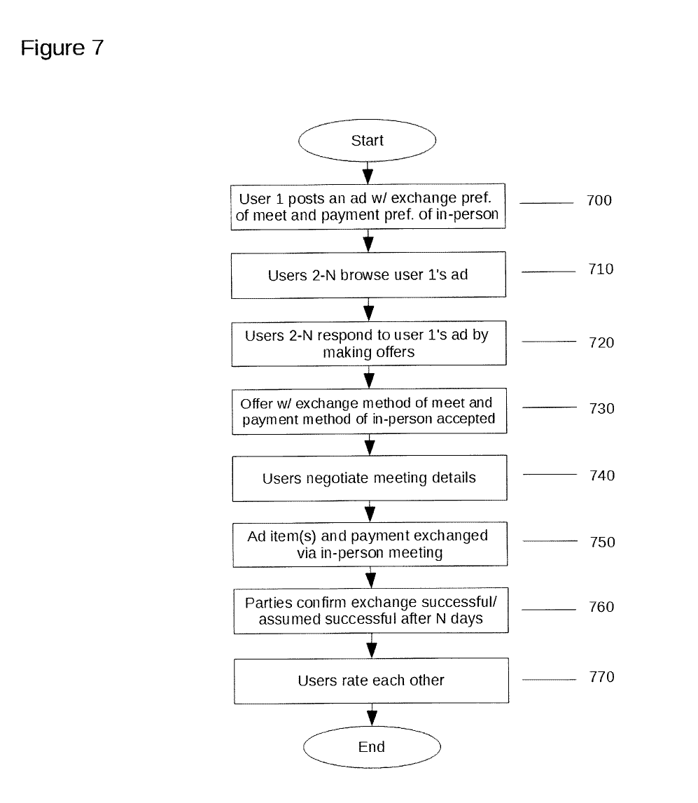

FIG. 7 is a flow diagram illustrating the process of offer and acceptance applied to online classified ads involving a payment that is made in-person according to one embodiment of the present invention.

At block 700, a user posts an ad to the online classified ad system specifying an exchange preference of meeting and a payment preference of in-person. The ad may be for a good or service wanted, a good or service for sale, a good or service for trade for another good or service, or any other type of classified ad involving the exchange of a good or service.

At block 710, users of the online classified ad system may view the ad posted in block 700.

At block 720, users of the online classified ad system may respond to the ad posted in block 700 in the form of offers.

At block 730, the poster of the ad or an agent on the behalf of the poster accepts an offer that has a payment method of in-person specified.

At block 740, users negotiate the details of an in-person meeting to complete the exchange.

At block 750, users or delegates of the users physically meet in-person at the agreed upon location, date, and time, and complete the exchange of ad item(s) and payment.

At block 760, the exchange of ad item(s) is recorded as complete in order to preclude the ad from being included in future search results. Also, if the accepted offer was based on an ad, the ad the offer was based upon is also closed in order to preclude it from being included in future search results.

At block 770, the poster of the ad and the creator of the accepted offer may rate each other based upon their overall experience with the other party and can also provide reviews of their experiences.

FIG. 8 illustrates a user interface screen through which a person may post an online classified ad according to one embodiment of the present invention.

In section 800, the user may select via a selection input, which may be a drop down, image, radio button, text field, or the like., a type for the online classified ad, such as:

Buy, for an ad expressing the user's intent to buy one or more good(s) and/or service(s).

Sell, for an ad expressing the user's intent to sell one or more good(s) and/or service(s).

Trade, for an ad expressing the user's intent to trade one or more good(s) and/or service(s) for one or more other good(s) and/or service(s).

Rent, for an ad expressing the user's intent to rent one or more good(s) and/or service(s) from another entity.

Lease, for an ad expressing the user's intent to lease one or more good(s) and/or service(s) to a lessee.

Hire, for an ad expressing the user's intent to hire an individual.

Work, for an ad expressing the user's intent to seek work.

Personals, for an ad expressing the user's intent to seek a personal relationship with another individual.

In section 805, the user may select via a selection input a category and/or subcategories for the good(s) and/or service(s) to be described in the online classified ad. The categories and any subcategories available for selection in the selection input are associated with Type 800. That is, the categories and any subcategories available for selection in the input depend on the value chosen for Type 800. For example, the Sell ad type may have categories Books, Computers, Vehicles, etc. The Personals ad type may have categories Men Seeking Women, Women Seeking Men, etc. In one embodiment of the present invention, the user may upload media such as images or videos depicting the item to be described in the ad, and the category and subcategory values may be detected via object recognition software; however the user will still have the option of changing the category or subcategories in the event the object recognition software chose the wrong categories.

Note that the category and subcategory relationship may extend infinitely deep and subcategories are displayed in the user interface in a faceted navigation style. For example, a Sporting category may have the children Golf, Tennis, etc. The Golf category may have the children Golf Clubs, Golf Club Sets, Golf Balls, Golf Bags, etc. The Golf Clubs and other child categories of Golf may have their own subcategories, and so on. When the user chooses a category, any subcategories of the selected category are shown on the screen in a faceted manner in another drop-down menu; the user may then select a subcategory from the subcategory drop-down, at which point any child categories of the subcategory are shown on the screen in another drop-down menu, and so on. This hierarchical structure of categories is described in FIG. 4.

In section 810, the user may enter a title to summarize what good(s) and/or service(s) are to be described in the online classified ad; the title is also useful for showing in search results when other users perform searches.

In section 815, if Type 800 involves the exchange of money, the user may enter a price. In the case of the procurement ad types (Buy, Rent, Hire), the Price field indicates the amount of money the user is willing to pay in order to receive the good(s) and/or service(s) described in his or her ad. In the case of the sale ad types (Sell, Lease, Work), the Price field indicates the amount of money the user is willing to receive for the good(s) and/or service(s) described in his her ad. The Price field is not relevant for the Trade or Personals ad type.

In section 820, if Type 800 involves the exchange of items, the user may select the exchange method required for the items. To require that ad items be exchanged via shipment, the user may select the radio button labeled “Ship.” To require the ad items be exchanged via an in-person meeting, the user may select the radio button labeled “Meet.” To indicate that there is no preference regarding how ad items are exchanged, the user may select the radio button labeled “No Preference.”

In section 825, if Type 800 involves the exchange of money, the user may select the payment method required for the items. To require that ad items be paid for online, the user may select the radio button labeled “Online.” To require the ad items be paid for in-persons, the user may select the radio button labeled “In-Person.” To indicate that there is no preference regarding how ad items are paid for, the user may select the radio button labeled “No Preference.”

In section 830, the user may enter his or her ZIP code to indicate where the item(s) described in the ad are located geographically.

In section 835, the user may enter values for the attributes of the categories chosen in section 805. The attributes shown depend on the most deeply nested subcategory selected in 805. Suppose there is a top-level category called Furniture with a child category Tables. If the user selected Tables as the category for his or her ad, input fields for the attributes of Tables would be shown in section 835.

Note, as discussed in FIG. 4, there is a hierarchical relationship between categories, and because of this, child categories inherit the attributes of their parent. In continuing with the Furniture and Tables example, suppose the Furniture category had attributes Style, Color, Material, and the Tables category had the attribute Number of Seats. If the user selects Tables as the category for the ad, input fields will be shown for the attributes of Tables as well as the attributes of Furniture, since Furniture is the parent of Tables. Therefore the user would see inputs for the following: Style (from Furniture), Color (from Furniture), Material (from Furniture), and Number of Seats (from Tables).

In section 840, the user may upload images representing the good(s) and/or service(s) expressed in the ad.

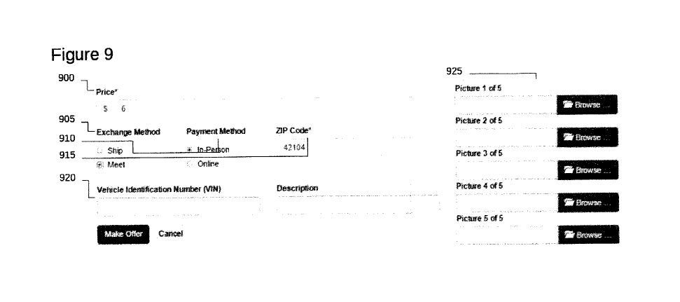

FIG. 9 illustrates a user interface screen through which a person may respond to an online classified ad (such as the ad in FIG. 8) by making an offer according to one embodiment of the present invention.

In section 900, if the ad type this offer is in response to (Type 800) involves the exchange of money, the offeror may enter a price. In the case of the procurement ad types (Buy, Rent, Hire), the offeror claims to possess the items described in the ad and thus the Price field on the offer user interface indicates the amount of money the offeror is willing to accept for the good(s) and/or service(s) described the ad. In the case of the sale ad types (Sell, Lease, Work), the offeror wishes to procure the items described in the ad and thus the Price field on the offer user interface indicates the amount of money the offeror is willing to pay for the good(s) and/or service(s) described the ad. The Price field is not relevant for the Trade or Personals ad type.

In section 905, if the ad type this offer is in response to (Type 800) involves the exchange of items, the offeror may select the exchange method for the items if the ad poster chose the “No Preference” option for the ad's exchange method field (820).

In section 910, if the ad type this offer is in response to (Type 800) involves the exchange of money, the offeror may select the payment method for the items if the ad poster chose the “No Preference” option for the ad's payment method field (825).

In section 915, the offeror may enter his or her ZIP code to indicate where the item(s) described in the offer are located geographically.

In section 920, the offeror may enter values for the offerable attributes of the ad's reciprocal category.

A reciprocal category is the reverse or complement of a given category. For example, the reciprocal of the Buy ad type's Cars category is the Sell ad type's Cars category, and the reverse is true: the reciprocal of the Sell ad type's Cars category is the Buy ad type's Cars category.

An offerable attribute is an attribute which is relevant in the context of an offer. For example, the Cars category under the Sell ad type has attributes Year, Make, Model, and Vehicle Identification Number (VIN). If a user posts an ad to sell a car, he or she may enter values for year, make, model, and VIN. However, in the context of an offer, only the VIN attribute should be available. It would not make sense for a user to post a Buy ad for a car specifying “1970” for Year, “Chevrolet” for Make, and “Chevelle” for Model, then to show the Year, Make, and Model field on the offer and allow the offeror to enter values for a completely different automobile; the offeror should only be allowed to enter a VIN on the offer.

In section 925, the offeror may upload images representing the good(s) and/or service(s) expressed in the offer.

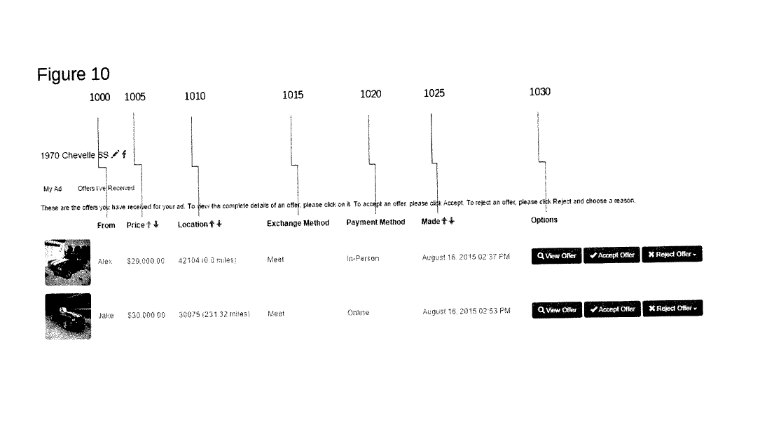

FIG. 10 illustrates a user interface screen through which the owner of an ad can accept one of many offers received for a given ad.

In section 1000, the name of the offeror is displayed.

In section 1005, if the ad type 800 involves the exchange of money, the price included in the offer is displayed. The user also has the option to sort the price in ascending or descending order by clicking the arrows next to the “Price” label.

In section 1010, the ZIP code of the offer is displayed as well as the distance in miles between the ZIP code on the ad and the ZIP code in the offer. The user also has the option to sort the distance in miles in ascending or descending order by clicking the arrows next to the “Location” label.

In section 1015, if the ad type 800 involves the exchange of items, the exchange method of the offer is displayed.

In section 1020, if the ad type 800 involves the exchange of money, the payment method of the offer is displayed.

In section 1025, a timestamp of when the offer was made is displayed. The user also has the option to sort the offer date in ascending or descending order by clicking the arrows next to the “Made” label.

In section 1030, the user has the option to accept or reject offers. The Accept Offer option allows the user to accept an offer. The Reject Offer option allows the user to reject an offer and to choose from a predefined set of reasons why the offer was rejected, such as offer price too high (for ads of the procurement ad types), offer price too low (for ads of the sale ad types), offer location too far away, not enough information in the offer, etc.

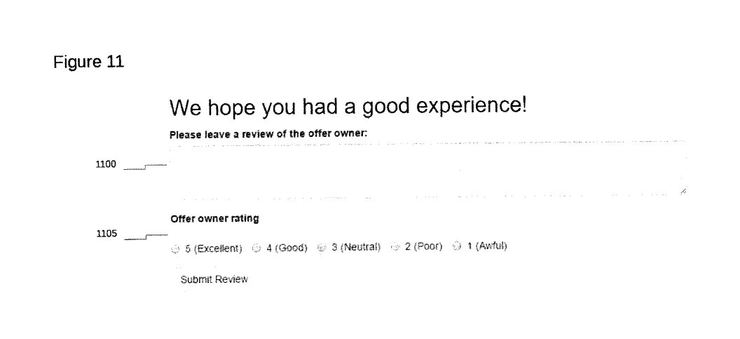

FIG. 11 illustrates a user interface screen available after a completed classified ad transaction in which the owner of the ad can leave a review and rating of the owner of the accepted offer.

In section 1100, the owner of the ad may enter a review of his or her experience with the owner of the accepted offer.

In section 1105, the owner of the ad may select a rating that best represents his or her experience with the owner of the accepted offer.

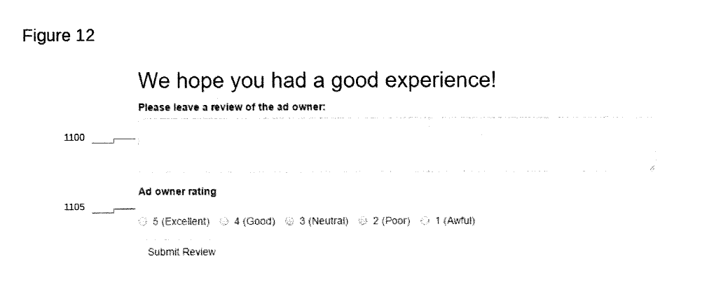

FIG. 12 illustrates a user interface screen available after a completed classified ad transaction in which the owner of the accepted offer can leave a review and rating of the owner of the ad.

In section 1200, the owner of the accepted offer may enter a review of his or her experience with the owner of the ad.

In section 1205, the owner of the accepted offer may select a rating that best represents his or her experience with the owner of the ad.

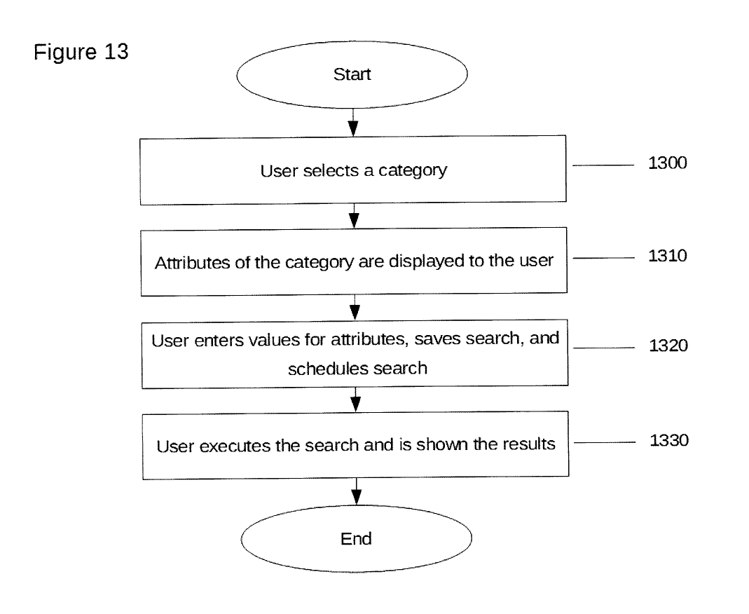

FIG. 13 is a flow diagram illustrating the process of saved searches of online classified ads according to one embodiment of the present invention.

At block 1300, the user selects a category.

At block 1310, the attributes of the category are displayed to the user.

At block 1320, the user enters values for any or all of the attributes of the category as well as the relevant properties of the ad type of the chosen category such as location, price, exchange method, payment method, or any other relevant property of the chosen category's ad type, and chooses to save the search so that it may be executed later without having to manually enter the values for the search parameters again. The user also schedules the saved search to execute periodically in an automated fashion; matches found by the automated search are sent as notifications to the user. In one embodiment of the present invention, the notifications are email messages containing hyperlinks to the ads matching the search criteria.

At block 1330, the user executes the search and is shown the results. The user may easily re-execute this search at any time because it was saved at block 1320. Also, the saved search will execute periodically in an automated fashion based on the schedule the user configured at block 1320.

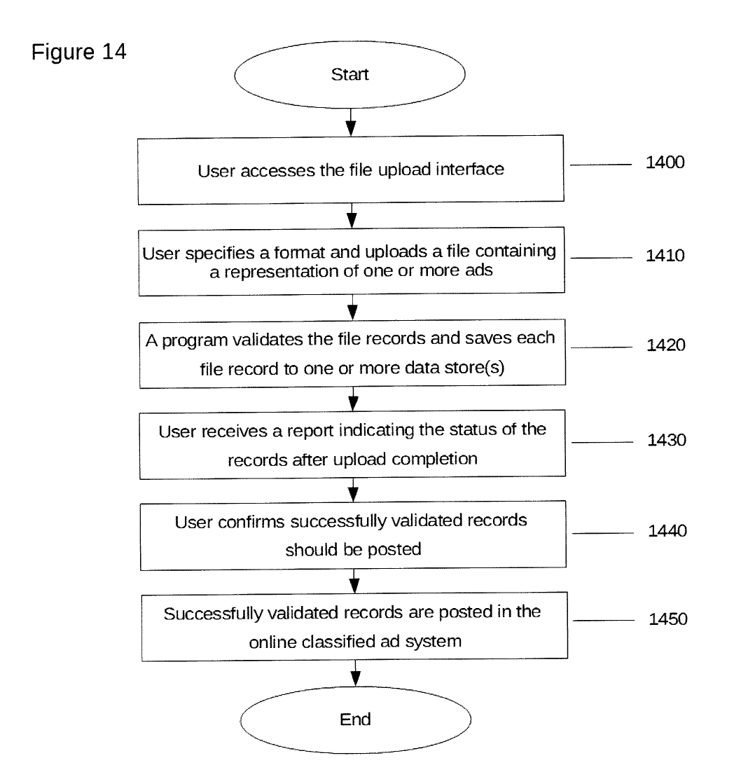

FIG. 14 is a flow diagram illustrating the process of uploading a file containing one or more records to an online classified ad data store for bulk creation of online classified ads according to one embodiment of the present invention.

At block 1400, a user accesses a file upload interface. The file upload interface may be Web page, a desktop application, a mobile phone or tablet application, or any other form of user interface.

At block 1410, the user specifies a file format and uploads a file in the specified format to a server such as Servers 110. In one embodiment of the present invention, if no format is specified, the files are assumed to be in a certain format.

The records in the file may directly represent classified ads to the user uploading them, or may represent other forms of information, such an inventory or stock. Also, the file may be based on customized formats or industry standard formats such as the Electronic Data Interchange (EDI) 846 inventory format.

At block 1420, a program on the server processes the file by performing validation and saving each record to one or more ad data stores such as a database. The successfully validated records are not immediately available in the online classified ad system as ads until the user who uploaded them reviews them and indicates they should be posted.

At block 1430, the user who uploaded the file reviews a report on the status of each record that was included in the upload. In one embodiment of the present invention, the report is rendered to the user via the file upload user interface upon upload completion. In another embodiment of the present invention, the report is saved for later viewing, and the user is notified via one of more notification mediums such as email that the upload is complete and requires reviewing before the records can be posted as ads in the online classified ad system.

At block 1440, the user confirms that the records that were successfully validated should be posted (i.e., made available) in the online classified ad system.

At block 1450, the online classified ad system performs any processing needed to put the uploaded ads in a viewable state in the online classified ad system's user interface(s).

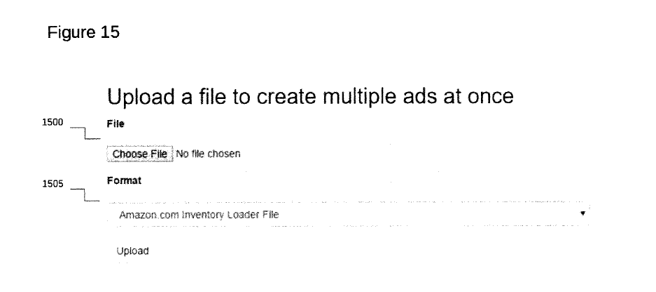

FIG. 15 illustrates a user interface screen through which a user may upload a file containing one or more records for bulk creation of online classified ads according to one embodiment of the present invention.

In section 1500, the user may select a file from his or her computer containing one or more records representing goods and/or services.

In section 1505, the user may select a format for the input file chosen in section 1500.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A system for facilitating buying, selling, trading, or other exchange of goods or services described in online classified ads by supplementing an online classified ad system with advanced searching and matching capabilities and an offer/acceptance model comprising:
a. A database for saving ads in an online classified ad system for quick manual execution or later or automatic scheduled execution, said advertisements including data relating to categories, attributes of such categories, sub-categories of said categories and attributes of said sub-categories;
b. A computing unit for matching online classified ads that represent searches for a good and/or service to ads capable of fulfilling said good and/or service based on comparative matching of said categories, subcategories of said categories and attributes, and notifying the ad posters of the matches found for their ads; and,
c. A system generated interface deployable over said network which includes a type selection input for selecting a type of ad based on a user's intent in posting the ad.

2. The system as defined in claim 1 wherein said type selection input on said system generated interface to the add system includes the type choices of buy, sell, trade, rent, lease, hire, work, and personals.

3. The system as defined in claim 1 wherein said system generated interface to the ad system includes a category selection input for selecting the subject matter of an ad based on the user's intent in posting the ad.

4. The system as defined in claim 3 wherein said category selection input for selecting the subject matter of an ad based on the user's intent in posting the ad includes a subcategory selection input for selecting a more narrow range of subject matter within each category.

5. The system as defined in claim 4 wherein said subcategory selection input includes at least one further subcategory selection input for selecting a more narrow range of subject matter within each subcategory.

6. The system as defined in claim 3 wherein said system generated interface to the ad system includes an attribute selection input for selecting an attribute of the subject matter selected in said category selection input.

7. The system as defined in claim 6 wherein said system generated interface to the ad system includes a subcategory attribute selection input for selecting an attribute of the subject matter in addition to attributes defined with respect to subject matter selected in said category selection input.

8. The system as defined in claim 1 further comprising a second system generated interface for users to respond to an online classified ad by making an offer.

9. The system as defined in claim 8 further comprising a system generated interface to the ad system for a poster of an online classified ad to accept an offer.

10. The system as defined in claim 9 wherein said system generated interface includes a field for each ad to be recorded in said database as complete once an offer is accepted in order to preclude the ad from being included in future search results.

11. The system as defined in claim 10 wherein said system generated interface includes a field for each ad matched and accepted to be recorded in said database as closed in order to preclude said ad from being included in future search results.

12. The system as defined in claim 9 wherein said a system generated interface includes a field for the users to confirm in said database that the exchange of ad items is successful.

13. The system as defined in claim 12 wherein said computing unit is configured to automatically mark said database that an exchange of ad items is successful at a predetermined number of days after an ad is accepted.

14. The system as defined in claim 1 wherein each category, subcategory and the attributes relating thereto has a complementary category, subcategory and attributes relating thereto having reciprocal relationships therewith such that ads of a category should only be matched to ads of a complementary category.

15. The system as defined in claim 14 wherein said database includes a field for each complementary ad matched and accepted to be recorded as closed in order to preclude said ad from being included in future search results.

16. The system as defined in claim 14 wherein said system generated interface to the ad system includes a category selection input for selecting the subject matter of an ad based on the user's intent in posting the ad.

17. The system as defined in claim 16 wherein said category selection input for selecting the subject matter of an ad based on the user's intent in posting the ad includes a subcategory selection input for selecting a more narrow range of subject matter within each category.

18. The system as defined in claim 17 wherein said subcategory selection input includes another subcategory selection input for selecting a more narrow range of subject matter within each subcategory.

19. The system as defined in claim 15 wherein said system generated interface to the ad system includes an attribute selection input for selecting an attribute of the subject matter selected in said category selection input.

20. The system as defined in claim 19 wherein said system generated interface to the ad system includes a subcategory attribute selection input for selecting an attribute of the subject matter in addition to attributes defined with respect to subject matter selected in said category attribute selection input.

21. The system as defined in claim 1 further comprising a ratings interface for the parties involved in a completed online classified ad transaction to rate each other and leave reviews based upon their overall experience.

22. The system as defined in claim 1 further comprising a ratings interface for the parties involved in a completed online classified ad transaction that allows a user to select a rating that best represents his or her experience with the poster of the completed online classified ad transaction.

23. The system as defined in claim 1 further comprising a review interface for the parties involved in a completed online classified ad transaction that allows a user to post a review of his or her experience with the poster of the completed online classified ad transaction.

24. The system as defined in claim 1 further comprising a bulk creation user interface deployable over a network for uploading ads represented in an input file, said ads in said input file including data relating to said categories, subcategories and attributes.

25. The system as defined in claim 24 wherein said input file is an industry standard input file.

26. The system as defined in claim 24 wherein said industry standard input file includes for each ad: a defined category, one or more subcategory, and the attributes relating thereto for matching with ads having a complementary category and attributes relating thereto such that each ad in said industry standard input file should only be matched to ads of a complementary category, subcategory and attributes.

27. The system as defined in claim 1 wherein said database includes a field to be recorded for each ad that has been matched and accepted as complete in order to preclude matched and accepted ads from being included in future search results.

28. The system as defined in claim 1 further comprising a user report interface deployable over the network to show the user matching complementary ads, said interface including user response inputs to allow the user to interact with the matching complementary ads.

29. The system as defined in claim 1 wherein said system generated interface includes a field for a user to specify a method of payment.

30. The system as defined in claim 1 wherein said system generated interface includes a field for a user to specify a method of transfer of the subject matter specified in the ad.

31. The system as defined in claim 1 wherein each category, subcategory and the attributes relating thereto has a complementary category, subcategory and attributes relating thereto having a reciprocal relationships therewith such that ads of a category should only be matched to other ads of a complementary category having complementary attributes.
